(19) United States
(12) Patent Application Publication
(10) Pub. No.: US 2005/0283498 A1
(43) Pub. Date: Dec. 22, 2005

(54) System and method to build, retrieve and track information in a knowledge database for trouble shooting purposes

(75) Inventors: Wen-Chang Kuo, Hsinchu City (TW); Tien-Der Chiang, Dali City (TW); Chien-Chung Huang, Hsinchu City (TW); Mu-Tsang Lin, Hemei Township (TW); Yi-Lin Huang, Tainan City (TW); Chun-Yi Chen, Ji-an Township (TW); Chi Wang, Yilan City (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/873,553

(22) Filed: Jun. 22, 2004

(51) Int. Cl. G06F 17/30

(52) U.S. Cl. 707/104.1

(57) ABSTRACT

A method of building a problem troubleshooting database for use in a semiconductor manufacturing system includes storing semiconductor manufacturing problem data in a problem troubleshooting database; storing cause data in the problem troubleshooting database, the cause data being associated with respective problem data; storing solution data in the problem troubleshooting database, the solution data being associated with respective semiconductor manufacturing problem data and cause data; evaluating the effectiveness of the solution data; and updating the solution data with information with respect to the effectiveness determined in the evaluating step.

### BACKGROUND

The present disclosure relates to semiconductor fabrication facilities, and more specifically, to an electronic system and method to build, retrieve, and track a knowledge database for troubleshooting in maintaining semiconductor tools.

Since the invention of the integrated circuit (IC), the semiconductor industry has grown dramatically to today's ultra-large scale IC's (ULSIC's). This has been achieved by technological progress not only in materials, design, and processing, but also in fabrication automation. Advances in IC technology, coupled with a movement towards mass production, provide a driving force for automation. Automation brings higher quality, shorter cycle time and lower cost, which in return drive broader IC applications and higher market demand.

Integrated circuits are produced by multiple processes in a wafer fabrication facility (fab). These processes include, for example, thermal oxidation, diffusion, ion implantation, RTP (rapid thermal processing), CVD (chemical vapor deposition), PVD (physical vapor deposition), epitaxy, etch, and photolithography. Each process requires very precise control of numerous process parameters. This requirement is typically achieved by a complex system with both hardware and software, collectively referred to as “semiconductor tools.” Sometimes the terms tool, machine, and equipment are used interchangeably.

For example, a sputtering system has a multi-chamber work station, a vacuum system to provide reduced pressure, a chemical/gas supplier system to provide Argon and Nitrogen, a robotic system to transfer wafers from chamber to chamber, a temperature system to monitor and control chamber/wafer temperature, a high voltage source to produce plasma, and a rotating magnetron to provide uniform and high rate deposition. All of these tools must work correctly, precisely, and synchronously, according to a preset recipe for specific production. If any tool does not function correctly, is out of range, or is out of sequence, the process may fail.

When a tool has a malfunction or problem, equipment engineers are typically required to troubleshoot and fix the problem so that the tool will be available for production as soon as possible. The equipment engineer must have the proper equipment, guide book, and/or standard operating procedure (SOP) to repair the tool, or try to make the repair with available equipment and knowledge. This exacerbates the risk of future malfunction or problem due to an increased likelihood of human error.

Similarly, when a process fails to produce wafers meeting production specification, process engineers are required to do failure mode analysis (FMA), identify root cause(s), propose corrective actions, run split lots or engineer lots for evaluation, correct process including parameters, configuration, recipes and procedure accordingly, follow up product yield and statistical process control (SPC) charts. For example, when a wafer failed physical inspection or on-site test after completing a certain process such as thin film deposition, etching, or implanting, process engineers need to identify issues, collect data, do analysis including SPC chart analysis and commonality analysis, identify if it is process related or tool related and if the failure is production related or material related. Process engineers even are required to work together with equipment engineers when it is not clear the problem is tool related or process related, or when it is both process and equipment combined. Process engineers need to have process recipes, process failure history, production information, and FMA data to support trouble shooting. Process engineers are also required to have knowledge and experience on process and failures. This exacerbates the risk of future failure or problem due to an increased likelihood of human error.

Currently, there is a significant need for a method and system to assist engineers in maintaining semiconductor tools when they malfunction, assist engineers in pinpointing processes when they fail to produce production in specification. Valuable time is often wasted while an engineer searches for a hard copy or soft copy tool troubleshooting manual, tool down history, process failure history, SPC data, and FMA information.

### BRIEF DESCRIPTION OF THE DRAWINGS

FIG. 1 is a block diagram of a system, in one embodiment, to build, retrieve, and access a knowledge database for troubleshooting purpose.

FIG. 2 is a flowchart of a method to build, retrieve, and access a knowledge database according to the embodiment of FIG. 1.

FIG. 3 is a block diagram of a system, in one embodiment, to build a valid knowledge database.

FIG. 4 is a flowchart of a method to build valid knowledge database for troubleshooting employed in the embodiment of the system of FIG. 3.

FIG. 5 is a block diagram of another embodiment of a system to build a trouble shooting knowledge database.

FIG. 6 is a flowchart of a method to build the troubleshooting knowledge database for solving tool problems according to the embodiment of the system of FIG. 5.

FIG. 7 is a block diagram of a system for retrieving information from the knowledge database for tool maintenance purposes.

FIG. 8 is a flowchart of a method to retrieve information from the knowledge database for troubleshooting performed in one embodiment of the system of FIG. 7.

FIG. 9 is a flowchart of a method to track knowledge in the disclosed database system.

FIG. 10 is a fab system, within which the system of FIG. 1 may reside.

FIG. 11 is a computer system used in the system of FIG. 10.

FIG. 12 is one embodiment of a data structure used by the method of FIG. 2.

### DETAILED DESCRIPTION

The following description provides a new and unique method and system to build, retrieve, and track information in a knowledge database for problem solving in semiconductor manufacturing.

It is understood, however, that the embodiments below are not necessarily limitations of the present disclosure, but are used to describe a typical implementation of the disclosed system and method. Even though equipment maintenance is used as an exemplary embodiment of a system and a method constructed according to aspects of the present disclosure, the present disclosure may not be limited to build, retrieve, and track the knowledge database of equipment maintenance. It could be extended to semiconductor processing troubleshooting. It could be extended to other proper troubleshooting such as manufacturing management, product yield handling, and FMEA in design, prototype, qualification, and mass production.

The term semiconductor tool may include any type of semiconductor tool such as a single tool or a cluster tool for example. It may be a tool for processing or a tool for test and measurement. Tool problems may include mechanical malfunctions, inconsistent processing results, out of specification processing parameters, and process chamber contamination.

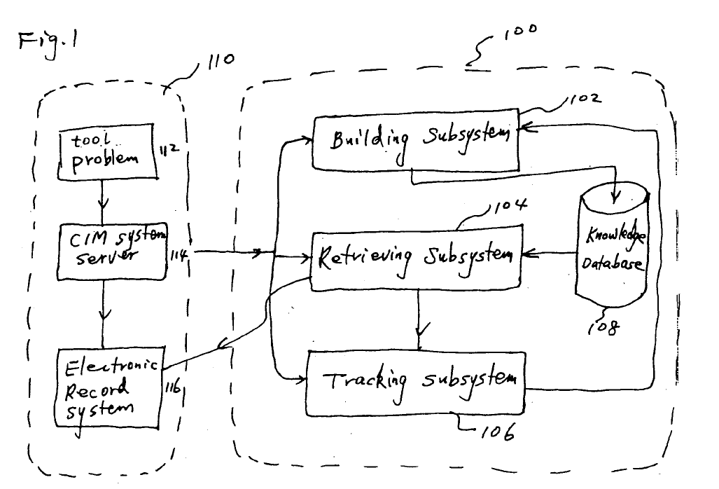

Referring to FIG. 1, a trouble shooting system according to one embodiment of the present disclosure is designated with the reference numeral 100. The system 100 may include a knowledge or information building subsystem 102, a knowledge retrieving subsystem 104, a knowledge tracking subsystem 106, and a knowledge database 108. The knowledge building subsystem 102 functions to evaluate tool problem data, and match solutions to each problem, with input from engineers on troubleshooting results or input from experts based on their knowledge and experiences. A troubleshooting solution to a problem could be a set of action, or a multi-step processing. The retrieving subsystem 104 functions to retrieve any solution from the knowledge database 108 for troubleshooting. The tracking subsystem 106 functions to evaluate each solution over period of time for its validity. The system 100 may be connected to fabrication system 110 which provides equipment problem data. Inside fabrication system 110, tool problem 112 will be passed to electronic record system 116 through computer integrated manufacturing (CIM) system server 114. The problem data is also sent to troubleshooting system 100, to provide raw data for the building subsystem 102 to build the knowledge database 108 during the initial stage of the knowledge database creation. The problem data can also trigger an alarm for a tool problem for the retrieving subsystem 104 when it retrieves information from the knowledge database 108 during tool maintenance. The problem data can also provide follow-up information for the tracking subsystem 106 to evaluate each set of actions. The tracking subsystem 106 feeds back a tracking result to building subsystem 102 for the purpose of updating knowledge database 108. The knowledge database 108 receives knowledge from the building subsystem 102 and provides solutions for the retrieving subsystem 104. The database 108 is retrievable by engineers for training purposes, inheritable from old model tools to new models, and transferable between different fabs and different sites.

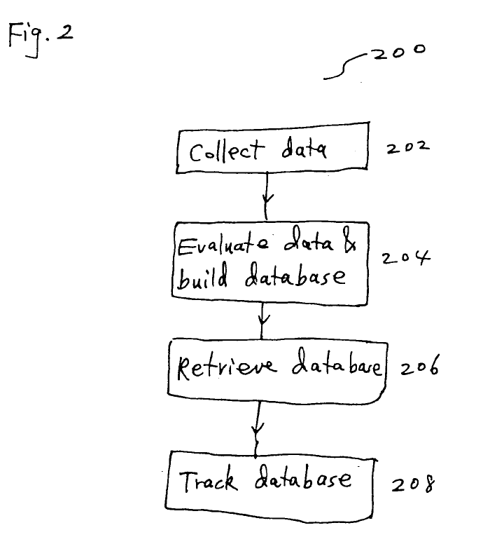

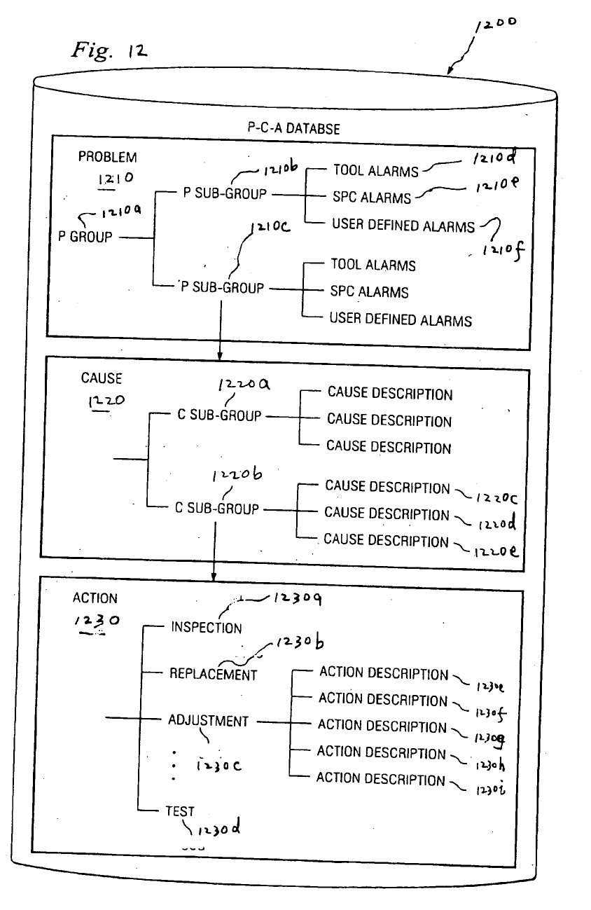

Referring to FIG. 2, one embodiment of a knowledge handling method is designated with the reference numeral 200. The method begins at step 202 in which tool problem data is collected from semiconductor processing tools or product through CIM. The collected information or data may include tool problems, product defects, statistical process control (SPC) information, out of specification (OOS) information, and wafer acceptance test (WAT) data. The tool problems may include mechanical malfunctions, inconsistent processing results, out of specification processing parameters, and process chamber contamination information. Product defects may include wafer cracking, non-uniformity, contamination, low yield issues, and OOS. Product defect data may also include the product type. SPC data may provide processing deviation, shifting, trend, or random changes which may be correlated to production defects and tool problems. WAT data may provide information such as the trend in production quality and yield. The collected data may also include input from engineers such as equipment problem causes, maintenance actions, special tool handling, and environmental events which could be associated with tool problems, such as power surging, and environmental factors (contamination, for example). This information is sorted, categorized, organized, and saved into a pre-structured database which includes a set of actions as solution for the problem. This database is referred to as troubleshooting record database. The database structure could be any proper and effective structure for retrieving and maintenance. In one embodiment, the database structure is a problem-cause-action (PCA) data structure such as described later with reference to FIG. 12.

In step 204, all collected troubleshooting record data will go through evaluation and building processing. Evaluation processing will evaluate each set of actions, as a troubleshooting solution, for its validation and efficiency, based on all collected information including the tool information such as tool available time, tool status, and product information such as product test results from WAT and wafer level reliability (WLR) test. All valid solutions would be built into the knowledge database 108. In the current step, experts may create new solutions for each tool problem based on their knowledge and experience if such solution is not available for any tool problem. These created solutions could also be retained into the knowledge database 108.

In step 206, if an alarm is triggered by a tool problem, then the knowledge database 108 will be retrieved for a proper solution in the knowledge database 108 based on all available information. The matched solution could be used for trouble shooting guide to assist engineers to solve the problem. The retrieving methods may be associated with a set of preset retrieving rules which could be different according to different strategies.

In step 208, all real cases will be tracked for further evaluation over a period of time. The step could may use information such as tools status after the actions and production yield to quantify efficiency level of each solution. An efficiency parameter may be used, dynamically maintained, and updated along with accumulation of troubleshooting data. Moreover, the efficiency parameter could be a function of tool entity, product type, and processing recipe. The efficiency parameter could be negative to present a disqualified solution which has negative impact over tool and production. Thus, both qualified and disqualified solutions could be combined into one database where the solutions with negative efficiency would be retrieved as a warning for engineers in trouble shooting. And the efficiency could be presented by more than one efficiency parameters. All tracking results will be used to update the knowledge database 108.

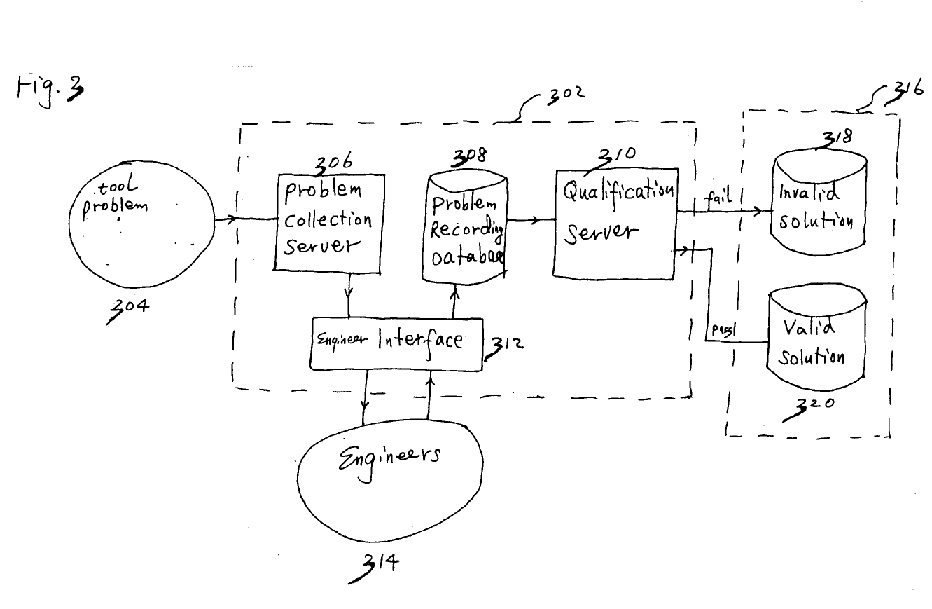

Referring to FIG. 3, one embodiment of a system to build a troubleshooting solution database is designated with the reference numeral 302. The system 302 includes problem collection server 306, qualification server 310, and engineer interface 312. The results of troubleshooting knowledge will be stored in the troubleshooting knowledge database 316 which may includes an invalid solution database 318 and a valid solution database 320. The problem collection server 306 functions to collect problem data from the data source 304 which includes tool problem data, tool process history such as SPC data, and production information such as product defect and failure data from WAT. The data source 304 is a virtual entity which represents all data from tools, manufacturing, and testing which are connected to a network and supported by CIM. Problem collection server 306 could automatically collect all trouble shooting related data from the data source 304, and may also process, sort, and categorize the data. The engineer interface 312 functions to present data in a certain format for engineers 314 and receives engineers' input which may include problem cause and actions taken. The engineer interface 312 may combine problem information from 304 and actions from engineers 314, and save the combined results to problem recording database 308. The engineers 314 may include equipment engineers, process engineers, or operators who have taken actions to solve the problem and who have authority to input such information. The problem recording database 308 stores all problem records. Each record has problem data and a solution/solutions associated with. All records could be retained in proper data structure. The qualification server 310 functions to analyze each problem record to qualify each set of actions for a valid solution by preset criteria, which may relate to tool available time, product test results, and mean time between failures (MTBF). The qualification server 310 also saves problem records to the valid solution database 320 upon being qualified or saves problem records to the invalid solution database 318 if a solution is disqualified.

The system 302 may have different components and configurations. For example, problem collection server 306, and engineer interface 312 may be combined into one server for information input from both tools and engineers.

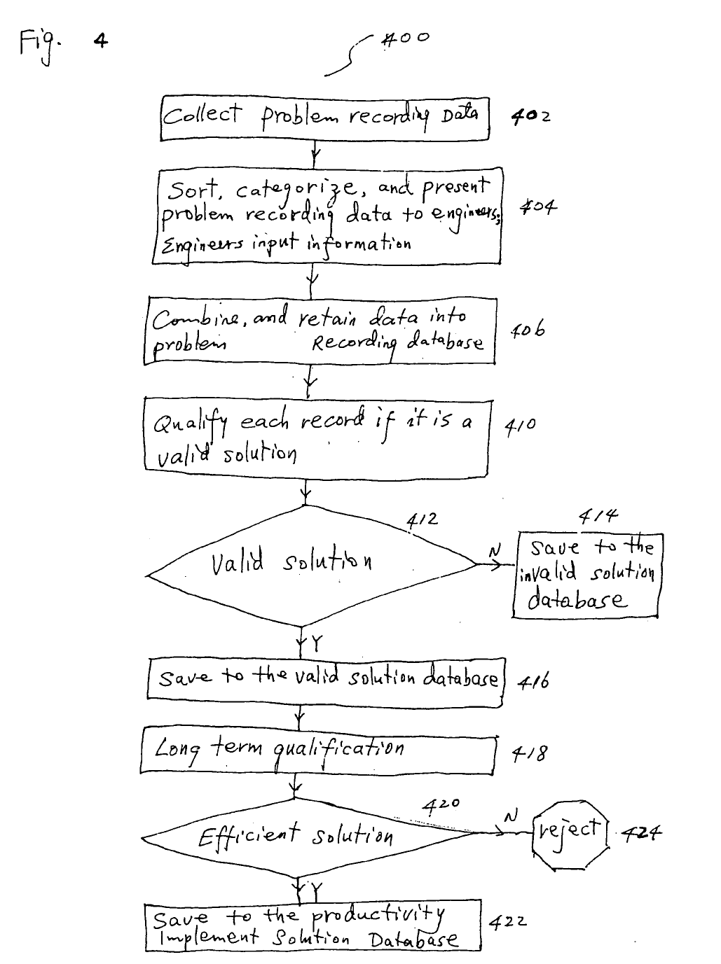

FIG. 4 shows one embodiment of a method 400 for building valid troubleshooting knowledge that may be performed in the system 302 of FIG. 3. The method 400 begins in step 402 in which problem collection server 206 could collect all problem recording data and related information. The collected information may include tool problems, product defects, SPC, OOS, and WAT. The tool problems may include mechanical malfunctions, inconsistent processing results, processing parameter out of specification data, and process chamber contamination data. Product defects may include wafer cracking, non-uniformity, contamination, low yield issues, and OOS. The product defect may also include the product type associated therewith. SPC data may provide all processing deviation, shifting, trend, or random changes which may be correlated to production defects and tool problems. WAT data may provide information such as trend in production quality and yield.

In step 404, the engineer interface 312 could sort, categorize, and present problem record data to engineers. Engineers such as equipment engineers could input problem-related information such as equipment problem causes, maintenance actions, special tool handling, and environmental events which could be associated with tool problems, such as power surging, and environmental contamination. The data processing including sorting and categorizing may be partially implemented by problem collection server 306.

In step 406, both information from the equipment and engineers could be combined, sorted, categorized, and saved into a pre-structured database referred to as problem recording database 308 which includes a set of actions as a solution for each problem. The database structure could be any proper and effective structure for retrieving and updating.

In step 410, the qualification server 310 could qualify each record in the problem recording database 308 for valid solution. Qualification processing evaluates each set of actions for its validity as a troubleshooting solution, based on all collected information in the associated record. The collected information may include the tool information such as tool available time, tool status, and product information such as product test results from WAT and WLR test.

In step 412, if a set of action is qualified to be a valid solution for trouble shooting, the qualification server will move to step 416 to retain it into the valid solution database. Otherwise, it will be saved into the invalid solution database in step 414. An related invalid solution will be communicated automatically to all of the related owners for caution and prevention in retrieving and troubleshooting.

In step 418, each solution in the valid solution database could go through long term qualification. This processing may be executed by the qualification server 310. Each solution will be evaluated for a long period of time for its efficiency based on long term information of equipment and products, for example, MTBF, wafer per hour (WPH), and yield rate. For further example, a tool MTBF could be analyzed before and after a valid solution was applied to the tool. If any shift of MTBF observed from before the action to after the action is positive and beyond a preset criteria, the solution would be qualified or partially qualified as a productive solution.

In step 420, if a solution is qualified through long term qualification, this solution will be retained into a database referred to as the productivity enhancement solution database (PESD) in step 422. Otherwise, the solution will be disqualified from productive implement solution in step 424. The productivity enhancement solution database may be used in troubleshooting for equipment engineer information to prioritize options optimize actions. Each solution in the productivity enhancement solution database may even further be labeled with efficiency parameter(s). For example, an efficiency parameter could be ranged from 0 to 1 where “1” represents for the most efficient solution while “0” represents for the most inefficient solution. A solution with the efficient parameter below a certain criteria could be transferred from the valid solution database to the invalid solution database. Or a solution with the efficient parameter above another criteria could be transferred or copied from the valid solution database to the productivity enhancement solution database.

In another example, the efficiency parameter could be even extended to a negative range where “0” represents a solution which does not have any positive or negative impact or result, while a negative value could represents a solution which will cause negative impact or disastrous impact to tool and production. Thus all three databases (invalid solution database, valid database, and productivity enhancement solution database) could be combined into one database where each solution is valued by an efficiency parameter and negative solution is provided as feedback to engineers as a warning like the function of the invalid solution database. However in this approach each solution is labeled quantitatively.

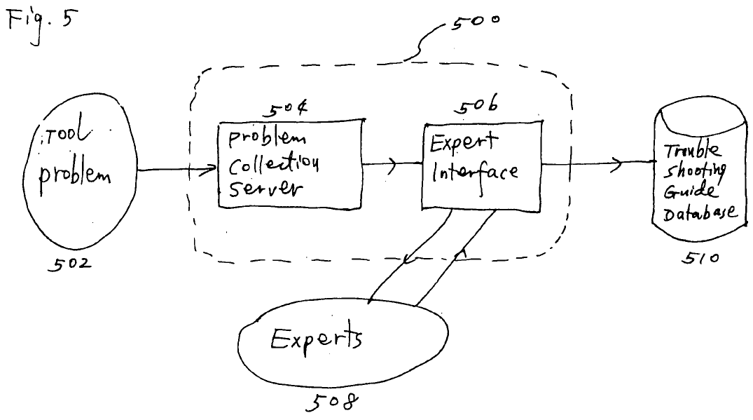

FIG. 5 shows one embodiment of a system 500 for building a troubleshooting solution or troubleshooting guide database. The system 500 includes problem collection server 504 and expert interface 506. The results of troubleshooting knowledge will be stored in the troubleshooting guide database 510. The problem collection server 504 collects problem data from the data source 502 which includes tool problem data, tool process history such as SPC data, and production information such as product defect and failure data from WAT. The data source 502 is a virtual entity which represents all data from tools, manufacturing, and testing which are connected to a network and supported by CIM. Problem collection server 504 could automatically collect all trouble shooting related data from the data source 502, and may also process, sort, and categorize the data. The expert interface 506 functions to present data in a predetermined format for experts 508 and take experts' input which may include problem cause and actions taken. The expert interface 506 may combine problem information from problem collection server 504 and actions from experts 508 and save the combined result to trouble shooting guide database 510. The experts 508 may include any person who has enough experience and knowledge to make a decision regarding what would be valid solution by either creating a new set of actions or matching to a set of actions from an action pool.

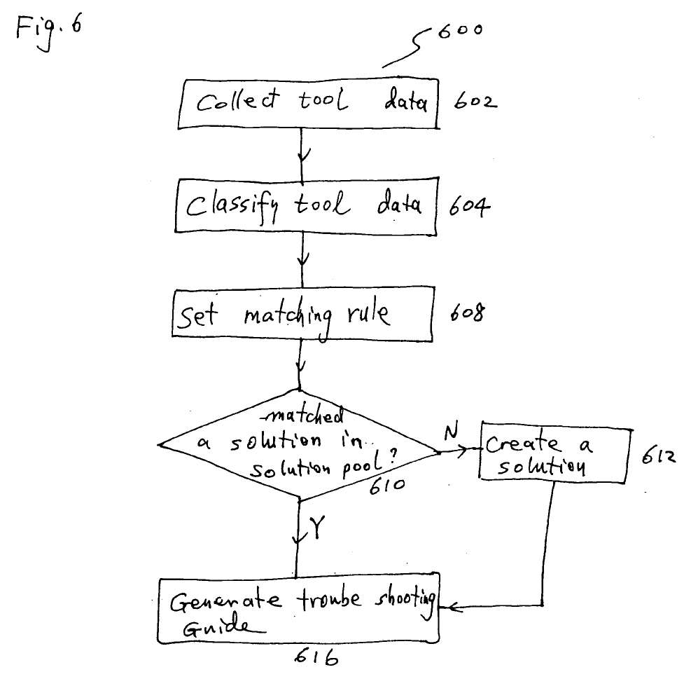

FIG. 6 shows one embodiment of a method 600 for building a troubleshooting guide database that may be performed in the system 500 of FIG. 5. Method 600 begins in step 602 in which problem collection server 602 could collect all problem data and related information. The collected information may include tool problems, product defects, SPC, OOS, and WAT. The tool problems may include mechanical malfunctions, inconsistent processing results, processing parameter out of specification, and process chamber contamination data. Product defects may include wafer cracking, non-uniformity, contamination, low yield issues, and OOS.

In step 604, the expert interface 506 could sort, classify, prioritize, and present problem data to experts.

In step 608, experts will set matching rules for the troubleshooting guide. In another embodiment, the matching rules could be set before the beginning of the method 600. In another embodiment, this step could be skipped, so experts could work out solutions for each problem only based on their own experience and knowledge.

In step 610, experts could select a set of actions, as a solution for each problem, from an actions pool based on either the matching rules, or their own experience and knowledge, or a combination of the both. The actions pool is an existing pool of actions which could be from log book, tool record, experts notebook or record, or vendor's troubleshooting manual. If such a solution is found and selected from the actions pool, then as per step 616 a solution record is stored in the troubleshooting guide database. Otherwise, as per step 612 experts will create a set of actions as a solution for the target problem. Any created solutions in step 612 will also be saved in troubleshooting guide database in step 616.

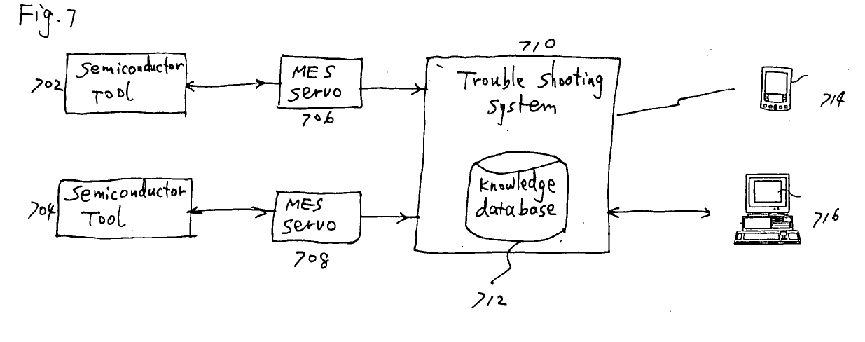

FIG. 7 shows one embodiment of a system 710 for retrieving knowledge from a database to assist engineers in troubleshooting. The troubleshooting system 710 includes a preset knowledge database 712. All semiconductor tools in different manufacturing plants (or fabs) are connected to the troubleshooting system 710 through servos of a manufacture execution system (MES) or CIM according to a well known Software Engineering Standards Committee (SESC) protocol. It is understood that the MES and SESC protocols are being discussed merely for the sake of example. For further example, only two semiconductor tools are illustrated: a first tool 702 linked to a servo 706 and a second tool 704 linked to a servo 708. The preset knowledge database 712 could be built either through the method 400 of FIG. 4, or by the method 600 of FIG. 6, or other proper method. The structure of the database 710 could be any effective structure for retrieving and updating. A problem-cause-action (PCA) data structure with a PCA tree structure is one example. A problem-action data (PAD) structure is another example. The database could be divided into a valid and an invalid sub-databases. Each record in the database could be associated with parameter(s) for its efficiency. In the present embodiment, all semiconductor tools of the same type share one common database 712. The troubleshooting system 710 is also linked to one or more terminals 714, and 716. For example, an electronic handheld computer device (PDA) 714 is linked to the system 710 via wireless 802.11B protocol, and a desktop computer 716 is linked to the system through an intranet wired system. Other examples of terminals include wireless telephones such as a cellular telephone, wired telephone which can be utilized, for example, by using an autodialer, and display panels that appear in a maintenance facility.

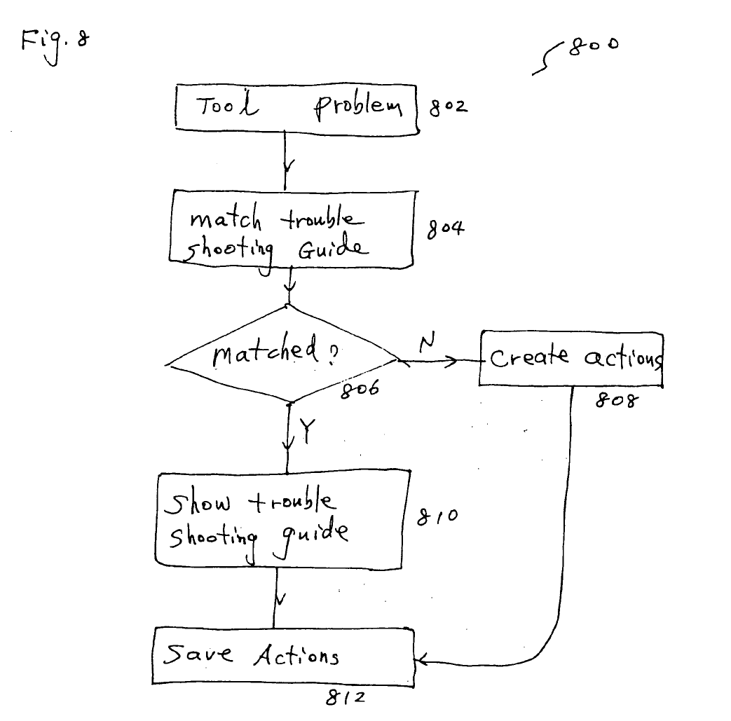

Referring now to FIG. 8, a method 800 is shown to retrieve information from a knowledge database to assist engineers in troubleshooting. Method 800 may be performed in the system of FIG. 7. Semiconductor tools are subject to many tool problems including mechanical malfunctions, out of range parameters, and software failures.

Beginning at step 802, if a tool problem occurs, the semiconductor tool 702 or 704 will send out a tool alarm to the troubleshooting system 710 through a connected MES servo 706, 708. A tool problem could be any problem related to the tool such as tool malfunction, tool contamination, parameters out of specification, tool related product failures such as wafer contamination, crack, OOS, low yield, or failures in WAT or WLR tests.

In step 804, the trouble shooting system 710 will correlate and match information from the tool alarm to the knowledge database 712, extract the description of the problem, possible causes and optional actions.

In step 806, if a matching solution is found in knowledge database 712, then flow continues to step 810. Otherwise, the step 808 is executed.

In step 808, the related tool overseers (e.g., equipment engineers responsible for the tool, manufacturers of the tool, and/or entities contracted to maintain the tool) will be informed of the problem through the PDA 714 or computer 716. The tool overseers create their own troubleshooting actions for this specific problem.

In step 810, a matched trouble shooting solution along with the tool alarm will be sent out to inform the related tool overseers through the PDA 714 or computer 716. The tool overseers can do failure mode analysis with assistance of the troubleshooting system 710 and finalize the trouble shooting actions.

In step 812, the trouble shooting system 710 will retain the actions which are selected and executed by the overseers. The executed actions could be matched actions, or created actions, or a modified version of the matched actions. The retained information will be saved as a part of the tool history.

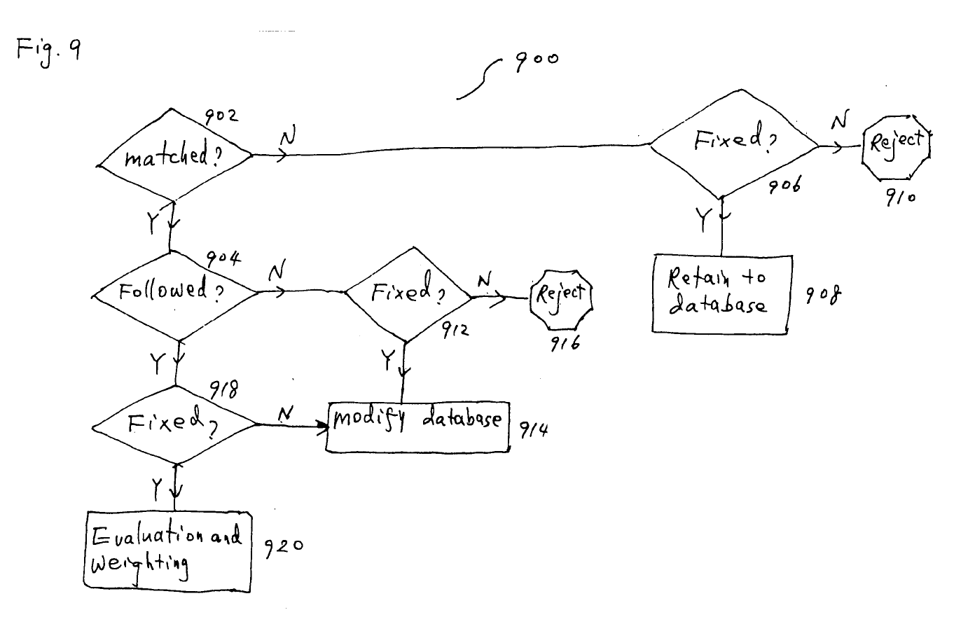

FIG. 9 shows a method 900 for tracking data in a knowledge database which may be performed in the system 100 of FIG. 1. Every troubleshooting case could be tracked through the method 900 for its validation and efficiency after a troubleshooting case is closed.

In step 902, there are two options for each closed troubleshooting case. One option is a solution which matches an existing solution in a troubleshooting knowledge database. Another solution is a solution created by engineers if there is no existing solution matching the case. If it is a matched solution, step 904 is executed. If it is a created solution, step 906 is executed.

In step 906, for a created solution, a test is conducted to determine if problem been fixed after the case is closed. If not, then stop further tracking. The solution will be rejected and dumped in step 910.

However, if the created solution fixed the problem, then it will be retained in the troubleshooting database as a valid solution to the problem in step 908.

In step 904, as the solution is a matched solution, a test is conducted to determine if the engineers exactly follow the matched solution. The test may include collecting information from an electronic tool logbook and engineering entry to the troubleshooting data, comparing between real shooting sequence and the matched solution in the troubleshooting database, and evaluating the difference. If the test determines the engineers followed the matched solution, step 918 is executed. If the real troubleshooting actions is a modified version of the matched solution, step 912 is executed.

In step 912, The case is evaluated to determine if the problem is fixed by the modified solution. The evaluation may be based on follow-up information including tool status, MTBF, and production yield correlation data. If the evaluation determines that problem is fixed, step 914 is executed. If the evaluation determines the problem is not fixed or only partially fixed, step 916 is executed in which the modified solution will be rejected.

In step 918, for a case wherein the troubleshooting action matched an existing solution and the existing solution is exactly followed, an evaluation is conducted to determine if the problem is fixed. The evaluation may include tracking tool status, MTBF, and production yield trend. If the problem is not fixed, step 914 is executed. If the problem is fixed, step 920 is executed.

In step 914, either the problem is fixed by the modified solution, or is not fixed by the matched solution, the trouble shooting database needs to be modified to incorporate the tracked result.

In step 920, if the matched solution is exactly followed and the problem is fixed, then the solution would be evaluated. In one embodiment, each solution is associated with an efficiency parameter and this parameter will be changed to stand for a higher efficiency level of the solution according to preset rules.

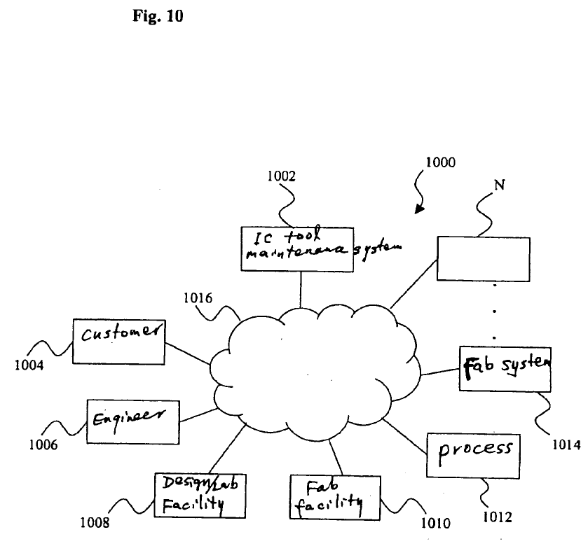

FIG. 10 shows one embodiment of an IC fabrication system (“fab system”) 1000 within which system 100 of FIG. 1 may reside or be included. Fab system 1000 includes a plurality of entities 1002, 1004, 1006, 1008, 1010, 1012, 1014, . . . , N that are connected by a communications network 1016. The network 1016 may be a single network or may be a variety of different networks, such as an intranet and the Internet, and may include both wireline and wireless communication channels.

In the present example, the entity 1002 represents IC tool maintenance system, the entity 1004 represents a customer, the entity 1006 represents an engineer, the entity 1008 represents a design/laboratory (lab) facility for IC design and testing, the entity 1010 represents a fabrication (fab) facility, and the entity 1012 represents a process (e.g., an automated fabrication process), and the entity 1014 represents another fab system (e.g., a fab system belonging to a subsidiary or a business partner). Each entity may interact with other entities and may provide services to and/or receive services from the other entities.

The entity 1002 may be a system 100 of FIG. 1, or a system 302 of FIG. 3, or a system 500 of FIG. 5, or a system 710 of FIG. 7, or any combination of them.

For purposes of illustration, each entity 1002-1012 may be referred to as an internal entity (e.g., an engineer, an automated system process, a design or fabrication facility, etc.) that forms a portion of the fab system 1000 or may be referred to as an external entity (e.g., a customer) that interacts with the fab system 1000. It is understood that the entities 1002-1012 may be concentrated at a single location or may be distributed, and that some entities may be incorporated into other entities. In addition, each entity 1002-1012 may be associated with system identification information that allows access to information within the system to be controlled based upon authority levels associated with each entities identification information.

The fab system 1000 enables interaction among the entities 1002-1012 for the purpose of IC manufacturing, as well as the provision of services. In the present example, IC manufacturing includes IC tool maintenance, IC process and the associated operations needed to produce the ICs, such as the fabrication, WLR testing, and WAT testing of the ICs.

One of the services provided by the fab system 1000 may enable collaboration and information access in such areas as design, process, engineering, maintenance, troubleshooting, and logistics. For example, in the design area, the customer 1004 may be given access to information and tools related to the design of their product via the service system 1002. The tools may enable the customer 1004 to perform yield enhancement analyses, view layout information, and obtain similar information. In the engineering area, the engineer 1006 may collaborate with other engineers using fabrication information regarding pilot yield runs, risk analysis, quality, and reliability. The logistics area may provide the customer 1004 with fabrication status, testing results, order handling, and shipping dates. It is understood that these areas are exemplary, and that more or less information may be made available via the fab system 1000 as desired.

Another service provided by the fab system 1000 may integrate systems between facilities, such as between the design/lab facility 1008 and the fab facility 1010. Such integration enables facilities to coordinate their activities. For example, integrating the design/lab facility 1008 and the fab facility 1010 may enable design information to be incorporated more efficiently into the fabrication process, and may enable data from the fabrication process to be returned to the design/lab facility 1010 for evaluation and incorporation into later versions of an IC. The process 1012 may represent any process operating within the fab system 1000.

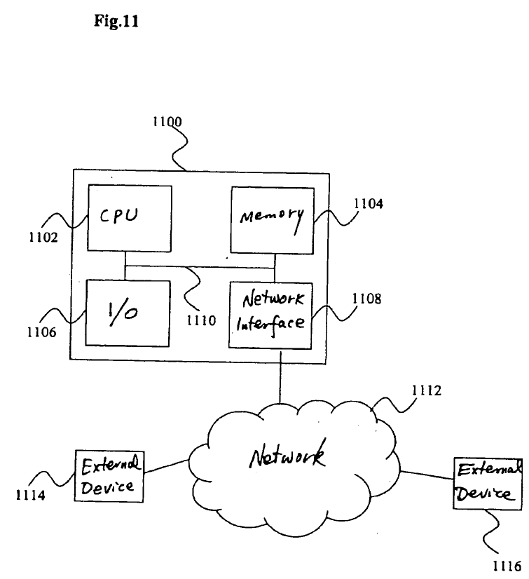

FIG. 11 shows an exemplary computer 1100, such as may be used within the fab system 1000 of FIG. 10. The computer 1100 may include a central processing unit (CPU) 1102, a memory unit 1104, an input/output (I/O) device 1106, and a network interface 1108. The network interface may be, for example, one or more network interface cards (NICs). The components 1102, 1104, 1106, and 1108 are interconnected by a bus system 1110. It is understood that the computer may be differently configured and that each of the listed components may actually represent several different components. For example, the CPU 1102 may actually represent a multi-processor or a distributed processing system; the memory unit 1104 may include different levels of cache memory, main memory, hard disks, and remote storage locations; and the I/O device 1106 may include monitors, keyboards, and the like.

The computer 1100 may be connected to a network 1112, which may be connected to the networks 416 of FIG. 4. The network 1112 may be, for example, a complete network or a subnet of a local area network, a company wide intranet, and/or the Internet. The computer 1100 may be identified on the network 1112 by an address or a combination of addresses, such as a media control access (MAC) address associated with the network interface 1108 and an internet protocol (IP) address. Because the computer 1100 may be connected to the network 1112, certain components may, at times, be shared with other devices 1114, 1116. Therefore, a wide range of flexibility is anticipated in the configuration of the computer. Furthermore, it is understood that, in some implementations, the computer 1100 may act as a server to other devices 1114, 1116. The devices 1114, 1116 may be computers, personal data assistants, wired or cellular telephones, or any other device able to communicate with the computer 1100.

FIG. 12 shows a preset PCA database structure 1200 which could be used by a database 108 of FIG. 1, or a database 316 of FIG. 3, or a database 510 of FIG. 5, or a database 712 of FIG. 7. The data structure 1200 includes a tree structure of tool problems that is linked to one or more causes. Each cause may be linked to one or more pertinent action(s) to fix the problem. Based on this PCA database 1200, the system 310 can start from a problem, trace down to cause(s) and search further to locate corresponding action(s).

Tool problems 1210 are in a tree structure by themselves. Tool problems 1210 may be categorized into many P groups. Each P group could be divided into many subgroups. Each P subgroup can be further divided into next level subgroups. Overall, this tree structure could have as many levels as necessary for the particular application. The lowest P sublevel will be further linked to all related alarms. In FIG. 12, as an example, there are three group levels including the tool alarms level for a single P group. P group 1210a can represent, for example, a software problem. Other P groups can include alignment problems, over-heating problems, and so forth. The P group 1210a includes, for the sake of example, two P subgroups 1210b and 1210c. P subgroup 1210b can represent, for example, software problems with an automatic control system of a certain processing device and P subgroup 1210c can represent software problems with a user interface of the processing device. In this three-tier example, each of the lowest level P subgroups is specific and linked to specific alarms. To continue the previous example, the P subgroup 1210b includes Tool alarms 1210d, statistical process control (SPC) alarms 1210e, and user-defined alarms 1210f. User-defined alarms could be any alarm such as an alarm to remind for periodic routine maintenance. In this tree structure, the system defines each generic problem into a very specific problem, which has one or more specific alarms. Further and more significantly, each of the lowest P subgroups will be linked to a cause. For instance, P subgroup 1210c is linked to causes 1220.

The causes 1220 are also in a tree structure by themselves, similar to the problem tree structure. The causes may be categorized into many C groups and subgroups. Each C subgroup can be further divided into next level subgroups and so forth. Overall, this tree structure could have as many levels as necessary. C subgroups 1220a and 1220b are schematically shown as exemplary elements in a cause tree. Each of the lowest C subgroups would be more specific and linked to a set of cause descriptions. For example, C subgroup 1220b may be overheating, which is further linked to a set of cause descriptions 1220c, 1220d, and 1220e. Examples of cause descriptions include a blocked air vent, an obstruction, and an electrical short. Further, each lowest level C subgroup will be linked to an action. For instance, C subgroup 1220b is linked to actions 1230.

The actions 1230 are also in a tree structure by themselves, similar to the problem tree and the cause tree structures. The actions may be categorized into many A groups and subgroups. Each A subgroup can be further divided into next level subgroups. Overall, this tree structure could have as many levels as necessary. Examples of A subgroups include inspection 1230a, replacement 1230b, adjustment 1230c, and test 1230d. Each of the lowest A subgroups would be more specific and is linked to a set of action descriptions. For example, A subgroup 1230c is linked to a set of action descriptions adjust valve 1230e, adjust stage motor 1230f, adjust stage height 1230g, adjust stage pitch 1230h, and adjust stage rotation 1230i.

The present embodiments may have many different benefits. Equipment maintenance knowledge could be built up continuously and dynamically. The acquisition and accumulation processing will not be scattered and isolated from engineer to engineer, from tool to tool, from fab to fab, from site to site, even from company to company. Instead, all knowledge is commonly shared and will not be interrupted by an engineer leaving and manufacturing changes. The accumulated knowledge will be maintained and updated over time. One solution could be efficient at first but become relatively inefficient later due to changes or shifting in manufacturing, process, and product changes, or only because the troubleshooting solution database become more thorough and mature. Such a solution may need to be removed from a knowledge database or have its efficiency level reevaluated.

Such a maintained knowledge database may be used for tool maintenance, junior engineer training and tutoring, technology evaluation, communication between fabrication plants, information sharing, and feedback to equipment manufacturing for research, improvement, and upgrading. The invalid solution database may be used to prevent disaster impact or eliminate previous failures.

The present embodiments provide ways to build a valid and efficient troubleshooting knowledge database to help engineers in maintaining semiconductor processing equipment. The present disclosure may not be limited to build, retrieve, and track the knowledge database of equipment maintenance. It could be extended to other types of troubleshooting database such as processing, manufacturing management, product yield handling, and failure mode effect and analysis (FMEA) in design, prototype, qualification, and mass production.

The present disclosure has been described relative to a preferred embodiment. Improvements or modifications that become apparent to persons of ordinary skill in the art only after reading this disclosure are deemed within the spirit and scope of the application. It is understood that several modifications, changes and substitutions are intended in the foregoing disclosure and in some instances some features of the disclosure will be employed without a corresponding use of other features. Accordingly, it is appropriate that the appended claims be construed broadly and in a manner consistent with the scope of the disclosure.

1. A method of building a problem troubleshooting database for use in a semiconductor manufacturing system comprising:
storing semiconductor manufacturing problem data in a problem troubleshooting database;
storing cause data in the problem troubleshooting database, the cause data being associated with respective problem data;
storing solution data in the problem troubleshooting database, the solution data being associated with respective semiconductor manufacturing problem data and cause data;
evaluating the effectiveness of the solution data; and
updating the solution data with information with respect to the effectiveness determined in the evaluating step.

2. The method of claim 1 including receiving input from a user with respect to the effectiveness of solution data received from the database.

3. The method of claim 2 including repeating the updating step after the receiving step.

4. The method of claim 1 wherein data is stored in the problem troubleshooting database in the form of problem-cause-solution data structures.

5. The method of claim 1 wherein the evaluating step includes testing solutions and classifying solutions as one of valid solutions and invalid solutions.

6. The method of claim 1 wherein the evaluating step includes matching solutions to existing solutions in the problem troubleshooting database thus providing matching solutions.

7. The method of claim 6 wherein matching solutions are determined according to a plurality of match rules.

8. A method of retrieving information from a problem troubleshooting database for a semiconductor manufacturing system comprising:
storing semiconductor manufacturing problem data in a problem troubleshooting database;
storing cause data in the problem troubleshooting database, the cause data being associated with respective problem data;
storing solution data in the problem troubleshooting database, the solution data being associated with respective semiconductor manufacturing problem data and cause data;
querying the problem troubleshooting database with a current problem; and
determining if the problem troubleshooting database includes a matching cause and solution for the current problem.

9. The method of claim 8 including displaying a particular solution matching the current problem.

10. The method of claim 9 including receiving input from a user with respect to the effectiveness of solution matching the current problem.

11. The method of claim 10 including tracking the effectiveness of solutions by updating the solution data with input from the user regarding the effectiveness of the solution matching the current problem.

12. The method of claim 9 including receiving input from the user of an alternative solution when the particular solution matching a current problem is ineffective.

13. The method of claim 12 including storing the alternative solution in the problem troubleshooting database.

14. A troubleshooting system for use in semiconductor manufacturing comprising:
a knowledge database to store problem data and solutions associated therewith;
a building subsystem, coupled to the knowledge database, to collect, sort and evaluate problem data in cooperation with the knowledge database;
a retrieving subsystem, coupled to the knowledge database, to retrieve an existing solution that matches a particular problem; and
a tracking subsystem to evaluate the effectiveness of the solutions over time.

15. The troubleshooting system of claim 14 wherein a communication is received by the troubleshooting system from a semiconductor manufacturing system.

16. The troubleshooting system of claim 15 wherein the communication includes problem data from tools in the semiconductor manufacturing system.

17. The troubleshooting system of claim 15 wherein the communication includes problem data and production data from a computer integrated manufacturing (CIM) system.

18. The troubleshooting system of claim 15 wherein the communication includes solution data and tool status data from an electronic record system in which tool maintenance data are stored.

19. The troubleshooting system of claim 15 wherein the knowledge database comprises:
a problem group having information describing a problem, wherein the information is collected from the semiconductor manufacturing system;
a cause group listing causes to the problem, wherein the causes are collected from the semiconductor manufacturing system; and
an action group having a record of actions which are evaluated as an effective method to solve the problem.

20. The troubleshooting system of claim 19 wherein the problem group includes a plurality of problem subgroups, each of the problem subgroups including tool alarm data, SPC data, and a set of user-defined alarm data.

21. The troubleshooting system of claim 19 wherein the cause group includes a plurality of cause subgroups, each of the cause subgroups further including a plurality of cause descriptions.

22. The troubleshooting system of claim 19 wherein the action group includes:
instructions for performing an inspection;
instructions for performing a replacement;
instructions for performing an adjustment; and
instructions for performing a test.
